(19) United States
(12) Patent Application Publication
(10) Pub. No.: US 2006/0224684 A1
(43) Pub. Date: Oct. 5, 2006

(54) Multimedia messaging method and system

(75) Inventors: Folkert Gaayo Miedema, Eindhoven (NL); Edwin Zuidema, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics

(21) Appl. No.: 10/552,079

(22) PCT Filed: Apr. 2, 2004
(86) PCT No.: PCT/IB04/50382

§ 371 Date: Oct. 4, 2005

(30) Foreign Application Priority Data
Apr. 10, 2003 (EP) 03100964.0

(51) Int. Cl. G06F 15/16

(52) U.S. Cl. 709/207

(57) ABSTRACT

A system for and method of controlling retransmission of a content item contained in a multimedia message, comprising receiving the message containing the content item from a sender together with an identifier of an intended recipient of the message, obtaining an identifier for the content item, retrieving approval information from a provider based on the identifier for the content item, and controlling retransmission of the message including the content item to the intended recipient based on the retrieved approval information. Controlling may comprise e.g. charging a fee for the retransmission, restricting forwarding of the content item or disallowing the retransmission. If the additional information identifies plural providers, retransmission can be made conditional upon approval by any of the plural providers.

The invention relates to a method of controlling retransmission of a content item contained in a multimedia message. The invention further relates to a system arranged for controlling retransmission of a content item contained in a multimedia message.

Multimedia Messaging Service (MMS) is a standard that lets users send and receive multimedia messages with formatted text, graphics, audio and video clips. MMS messages can be sent to (MMS enabled) mobile phones or standard e-mail addresses. The sending entity can for instance be a mobile phone or an application running on a computer.

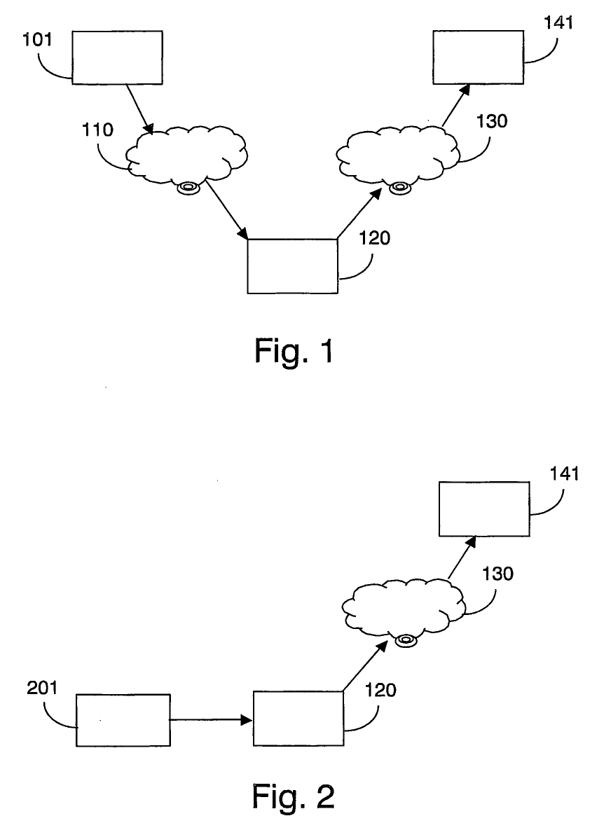

FIG. 1 shows the generic MMS Person-to-Person flow. A first person wants to send an MMS message to a second person. He takes his mobile phone 101 or other MMS user agent, composes the message and includes one or more multimedia objects in the message. After hitting the “send” button, the multimedia message (text and the multimedia objects) is transmitted over a mobile network 110 to a Multimedia Messaging Service Center (MMSC) 120.

The mobile network 110 could be e.g. GSM, GPRS, UMTS or a comparable system. As multimedia messages can potentially grow very big, a broadband mobile network is preferred. The first person could also have composed the message on his personal computer connected to the Internet. The message would then have been sent to the MMSC 120 over the Internet. Other ways to transmit multimedia messages are of course also possible. It is important to note that the message is always sent to the MMSC 120 and not directly to the recipient. This architecture is an example of a store-and-forward messaging system.

The multimedia message is received by the MMSC 120. From there it is forwarded to the intended recipient (the second person). The multimedia message is once more transmitted over a mobile network 130, this time to the mobile telephone or other user agent 141 of the second person. Upon arrival of the multimedia message, this mobile telephone processes the content and presents the message to the second person. The two mobile networks 110, 130 in question may or may not be the same.

In the above example, the first person used the second person's telephone number as the address to which the multimedia message was to be sent. He could also have used the second person's e-mail address. The multimedia message would then have been forwarded by the MMSC 120 to the second person's e-mail box, from which the second person could have read it using a standard e-mail client.

FIG. 2 shows the generic MMS Application-to-Person flow. Multimedia messaging is of course not restricted to messages sent by persons to persons. Many automated services can be offered. For instance, a popular service is the making available of ringtones or logos for mobile telephones. In such an application, a user can send a request for a particular ringtone or logo to a server from his mobile telephone. An application 201 on the server retrieves the appropriate ringtone or logo and transmits it as a multimedia message to the MMSC 120. Once the message arrives at the MMSC 120, it is handled and forwarded in the same way as described above with reference to FIG. 1. When the mobile phone 141 receives the multimedia message, it extracts the ringtone or logo.

Delivering ringtones and logos is already very popular with the standard text-based Short Messaging Service (SMS). However, MMS has a much broader application. A potential use of Application-to-Person MMS is the provision of (high) value content. An example could be a service which can provide the latest music samples or video clips. The user pays an extra amount for that message to cover the content licensing costs, as most of this content is copyrighted or protected by other intellectual property rights.

A problem occurs if both presented models are combined: The user who paid for the content (application-to-person) can forward this message (and thus the content) to another user (person-to-person), only paying for the transmission of the message, but not paying any license fees due for forwarding the content.

It is an object of the invention to be able to restrict or otherwise control the forwarding of multimedia content.

This object is achieved according to the invention in a method as claimed in claim 1, and in a system as claimed in claim 10. According to the invention the service provider who originally provided the content item is contacted and forwarding is conditional upon his approval. This has the advantage that the entity handling the forwarding does not need to keep track of policy rules regarding when it is or is not allowed to forward a content item. Furthermore, any such rules can be changed at any time by the provider without having to update anything in the forwarding system. The sytem simply contacts the provider and learns from the response whether forwarding is permitted.

In an embodiment the invention uses robust fingerprints to identify the content transmitted in a multimedia message. The provider can be identified using a database lookup using the fingerprint as a key. A single fingerprint may be associated with identifiers for plural providers, which means that any of these providers can approve forwarding. This makes the invention very flexible in terms of licensing options and enables for example price-based competition between providers.

Restricting forwarding, for example by disallowing retransmission of the entire message, or by allowing retransmission of the message but disallowing retransmission of the content item, is usually desired. Another option is to allow forwarding of the content item and tracking such forwarding. By tracking the content, useful information about the distribution of the content can be gathered (for marketing purposes), but also business rules can be added to limit this distribution of the content.

Advantageous embodiments are set out in the dependent claims.

These and other aspects of the invention will be apparent from and elucidated with reference to the embodiments shown in the drawing, in which:

FIG. 1 schematically illustrates a multimedia messaging system in which messages from one user are passed via an MMSC to another user;

FIG. 2 schematically illustrates a multimedia messaging system in which messages from an application are passed via the MMSC to a user;

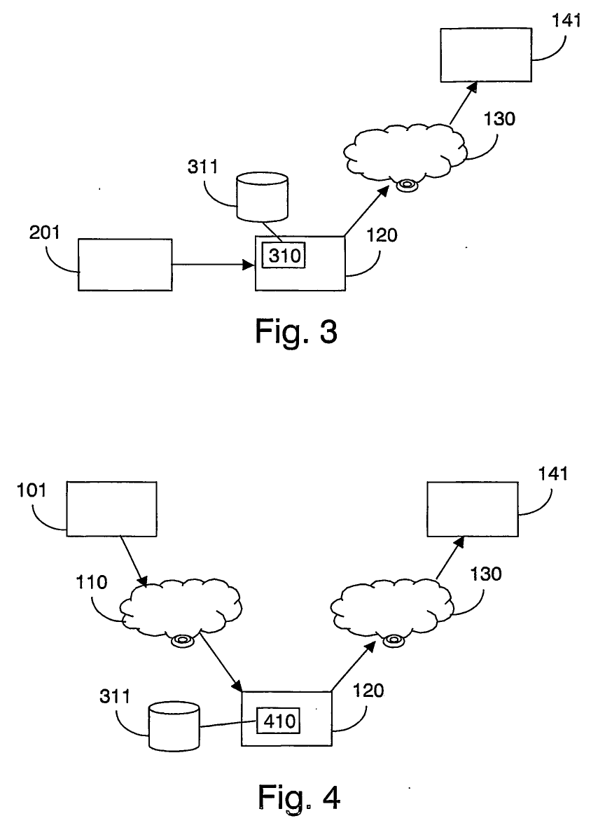

FIG. 3 schematically illustrates an preferred embodiment of the invention in which a fingerprinting module is added to the MMSC;

FIG. 4 schematically illustrates an embodiment of the invention in which a fingerprint-based identification module is added to the MMSC;

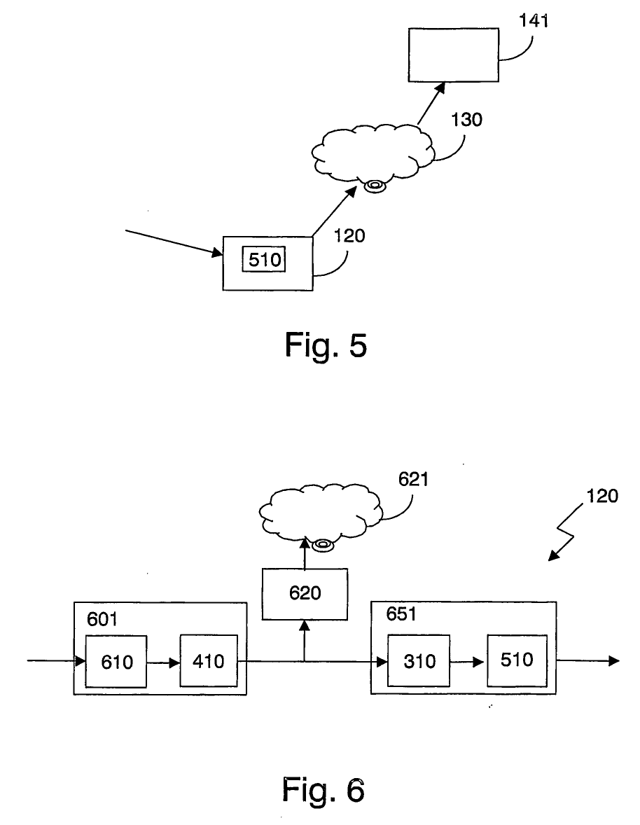

FIG. 5 schematically illustrates a Media Mediation System coupled to the MMSC; and

FIG. 6 schematically illustrates an embodiment of the MMSC.

Throughout the figures, same reference numerals indicate similar or corresponding features. Some of the features indicated in the drawings are typically implemented in software, and as such represent software entities, such as software modules or objects.

An illustration of a preferred embodiment of the invention is shown in FIG. 3. In this embodiment, the MMSC 120 is extended with a fingerprinting module 310 through which all content items present in multimedia messages must pass. The fingerprinting module 310 computes a fingerprint for the content item in question. This fingerprint serves as an identifier for the content item.

One method for computing a robust fingerprint is described in international patent application WO 02/065782 (attorney docket PHNL010110), although of course any method for computing a fingerprint can be used. The fingerprinting module 310 then performs a database lookup in database 311 to determine whether this particular fingerprint is present in the database 311. If not, the fingerprint of the content item in question is added to the database 311 together with an identifier for the sender of the content item. This sender then most likely is the original provider of the content item. If desired, an additional check can be performed to determine whether this is true before adding the sender to the database 311.

Another option is to add the fingerprint of any content item to the database 311 when it is first made available by the provider, not when it is first transmitted from the provider to a client.

The MMSC 120 is also provided with a fingerprint-based identification module 410, as shown in FIG. 4. The fingerprint-based identification module 410 retrieves additional information from the database 311 based on the fingerprint computed by the fingerprinting module 310. If additional information can be found, this indicates that the content has passed through an MMSC previously. This is proof that the content is being forwarded. As such forwarding is to be prevented or at least restricted, the MMSC 120 can now take appropriate action. It is noted that if multiple MMSCs are going to be used, the database 311 should be accessible to all MMSCs.

The simplest action is to simply delete the multimedia message rather than forwarding it. However, this may not be acceptable to users. Usually one part of the message (such as a picture or ringtone) represents forwarded content. Other parts, such as accompanying text messages or pictures, are original content. The original content should not be blocked simply because there is also a forwarded part in the message. The MMSC 120 could strip out this forwarded piece of content and pass on the remaining parts of the multimedia message. Preferably, any parts that have been stripped out are replaced by a message indicating that they have been stripped out and why.

Alternatively, a license fee required for forwarding the content could be computed. This license fee can then be charged to the sending user's account, if this information is available. This could work well e.g. with music content, as music rights clearinghouses are available to negotiate a general compensation or license fee.

The MMSC 120 could also convert the content to a relatively low quality version before forwarding the content to the intended recipient. This way, the intended recipient would still get the message and the content, but because of the low quality it would not be very valuable. He would then be encouraged to download the original version from the MMS application 201 himself.

The action can also comprise reporting the distribution of this content to a third party such as the service provider. Distribution can then be made conditional upon approval from the provider. This embodiment works best if an identifier for the provider is embedded in the content item.

Another example is the allowance of the forwarding, but billing the sending user a premium price for it. In mobile networks, the sending user can be identified e.g. through the telephone number to allow such billing. Price information can be appended to the message or be supplied in a separate message.

Appropriate action could be taken based on the retrieved additional information. For example, if the additional information identifies the initial recipient of the content being forwarded (i.e. the person who received it from the MMS application server in FIG. 2), the MMSC 120 could compare this identifier against an identifier for the sender of the intercepted multimedia message. If these two are the same, it could permit forwarding. This way, the initial recipient can forward content to his friends, but those friends cannot pass the message on to anyone else.

Alternatively, the identifier could be used to track down the initial recipient of the content, so that he can be charged a certain amount of money for this premium service, or so that he can be blocked from using the MMS application. He could also be offered a subscription before he is allowed to forward content items.

If the additional information identifies the MMSC which added the fingerprint to the database 311, or the operator of one or more MMSCs, the MMSC 120 could allow forwarding of the message if it were the same MMSC as the MMSC which added the fingerprint. This permits forwarding only to and from users of the same MMSC.

If the additional information identifies the provider of the content item, retransmission can be made conditional upon approval by that provider. This is preferably realized by having the fingerprinting module 310 store the computed fingerprint associated with an identifier for the provider in the database 311 if no identifier for the provider could be retrieved from the additional information. This way, the fingerprint-based identification module 410 can retrieve this identifier and contact the provider to obtain permission to retransmit the message and/or the content item, or to take any other action as explained above.

If the additional information identifies plural providers, retransmission can be made conditional upon approval by any of the plural providers. The fingerprint-based identification module 410 can now contact all of these providers and permits retransmission if at least one of them approves. If more than one provider approves, the most liberal approval could be applied, or the sender could be asked to pick one of the providers, or a selection could be made in some other way.

Identifying plural providers can be implemented by storing the fingerprint associated with one provider when it is found that the fingerprint is not yet in the database 311. If subsequently the fingerprinting module 310 notices that the fingerprint is in the database 311 but not associated with the sender of the content item, then an identifier for this sender can be added to the entry for that particular fingerprint. The fingerprint-based identification module 410 is then able to retrieve all the providers of the content item.

By using fingerprints, it becomes possible to identify one particular content item regardless of the transmission medium or the format in which it is encoded. For example, it can now be determined that two content items contain the same piece of music, even if the respective items originate from different providers. Using fingerprints is also robust against end users tampering with information such as filename, file size or any information embedded in the content item.

The fingerprinting module 310 and the fingerprint-based identification module 410 can be embodied as separate devices to be installed in the MMSC 120, or as separate devices connected to the MMSC 120. For example, the module 310 could be designed to operate as a proxy to be connected between MMS application 201 and MMSC 120, making operation transparent. Similarly, the module 410 can be designed as a proxy between MMSC 120 and mobile network 130. The modules 310, 410 can be embodied as one single device or module. They can be embodied in whole or in part in hardware or in software.

The entity operating the MMSC 120 is able to optimize content at the MMSC 120 for the receiving user agent using media mediation system 510, as shown schematically in FIG. 5. Optimization can be the adaptation or transcoding of the format (for images e.g., GIF to JPEG), the size (for video e.g., from CIF to QCIF), the bitrate (for audio e.g., 128 kbps to 20 kbps) and other parameters. Since this media mediation system 510 has access to, and knowledge about the multimedia content of the message, the modules 310, 410 are then preferably positioned in this system 510.

An illustrative embodiment of the MMSC 120 is shown schematically in FIG. 6. The functionality of the MMSC 120 can be divided conceptually into a server portion 601 and a relay portion 651. Briefly speaking, the server portion 601 provides the store-and-forward architecture and the relay portion 651 transcodes and delivers the messages.

A message is received by the receiver component 610 of the server 601. The message is processed to detect how it should be handled and to whom it should be forwarded. In accordance with the invention, the contents of the message is processed by the fingerprint-based identification module 410 to detect whether the multimedia content of the message has already been forwarded. If such detection is positive, the MMSC 120 takes appropriate action, as explained above.

If forwarding of the message is acceptable, there are several possible paths the message can take. Usually the message will be passed on to the relay 651. The relay 651 comprises the fingerprinting module 310 and the media mediation system 510 which transcodes the message to a form suitable for handling by the recipient. The message is then passed on to the mobile network 130 so that it can be delivered to the intended recipient.

The message can also be passed on to an SMTP interface 620 connected to a network 621 such as the Internet. This interface formats the multimedia message in accordance with Internet e-mail standards, and then forwards the message as an Internet e-mail message to the intended recipient. The SMTP interface 620 may or may not perform the above fingerprint-based check on the multimedia message before forwarding it. If the SMTP interface 620 does so, further forwarding of the resulting e-mail message to another recipient via the MMS network becomes impossible. However, as the Internet e-mail network is not very strictly regulated, it will be very difficult to enforce forwarding restrictions over the e-mail network itself.

If the recipient is not on the same mobile network as the sender of the multimedia message, the relay cannot forward the message itself to the intended recipient. In this case, the server passes the message on to an MMSC 630 which is connected to the correct mobile network.

The fingerprint-based identification module 410 can also be positioned in the relay portion 651 of the MMSC 120. This has the advantage that the module 410 and module 310 could e.g. be realized as a single device.

The functionality of the transcoding module 510 can be extended to more than just converting between formats, sizes, bitrates etcetera For instance, an interface with MMS applications could be provided. This way, an MMS application could for instance dynamically generate content specifically adapted for one particular mobile device.

It should be noted that the above-mentioned embodiments illustrate rather than limit the invention, and that those skilled in the art will be able to design many alternative embodiments without departing from the scope of the appended claims. For example, the modules 310, 410 could be incorporated in the user agents 101, 141. Instead of robust fingerprints, also for example cryptographic hashes, CRCs, filename-based identifiers or watermark-based identifiers could be used. A combination of different techniques for obtaining an identifier is also possible.

The invention is of course applicable to any store-and-forward system, for example i-mode/i-mail, WAP and all future mobile premium content ways of transport, not just the MMS system described above.

The content items that can be transported could be any type of content, for example (java) games, greeting cards (still and animated), location based services (eg city-maps, etc.), premium information content (news reports+pictures, stock-market info+graphics), screensavers, images/pictures (can be anything: music artists, playboy playmates, etc.), audio or video clips and so on.

It is for instance also possible to implement the fingerprinting and fingerprint-based lookup functionality according to the invention in an Internet or Intranet e-mail server system. This way e-mail messages cannot be used to indefinitely forward multimedia content. Analysis of the contents of e-mail attachments is already done by anti-virus software, and a similar approach could be used to compute fingerprints in attachments.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method of controlling retransmission of a content item contained in a multimedia message, comprising
receiving the message containing the content item from a sender together with an identifier of an intended recipient of the message,
obtaining an identifier for the content item,
retrieving approval information from a provider based on the identifier for the content item,
and controlling retransmission of the message including the content item to the intended recipient based on the retrieved approval information.

2. The method as claimed in claim 1, in which controlling retransmission comprises allowing retransmission of the message including the content item to the intended recipient and billing the sender or the intended recipient a premium price.

3. The method as claimed in claim 1, in which controlling retransmission comprises allowing retransmission of the message including the content item to the intended recipient and recording details regarding the retransmission.

4. The method as claimed in claim 1, in which controlling retransmission comprises restricting retransmission of the message.

5. The method as claimed in claim 4, in which restricting retransmission comprises disallowing retransmission of the message.

6. The method as claimed in claim 4, in which restricting retransmission comprises allowing retransmission of the message but disallowing retransmission of the content item.

7. The method as claimed in claim 1, in which information identifying the provider is retrieved from a database based on the obtained identifier.

8. The method as claimed in claim 7, in which the obtained identifier is stored associated with an identifier for the sender in the database if the information identifying the provider could not be retrieved from the database.

9. The method as claimed in claim 7, in which the information identifies plural providers, retransmission being conditional upon approval information retrieved from any of the plural providers.

10. A system arranged for controlling retransmission of a content item contained in a multimedia message, comprising receiving means for receiving the message containing the content item from a sender together with an identifier of an intended recipient of the message, identifying means for obtaining an identifier for the content item, lookup means for retrieving approval information from a provider based on the identifier for the content item, and for signaling to conditional retransmitting means the approval information, the conditional retransmitting means being arranged for controlling retransmission of the message including the content item to the intended recipient based on the approval information.

11. A media transcoding system, arranged for transcoding content items in a multimedia message to a format suitable for an intended recipient, comprising the system of claim 10.

12. A computer program product arranged for causing a processor to execute the method of claim 1.
